(19) United States
(12) Patent Application Publication
(10) Pub. No.: US 2009/0044671 A1
(43) Pub. Date: Feb. 19, 2009

(54) Punch press shedder pin knockout arrangement

(76) Inventor: Richard J. Greenleaf, Manchester by-the-sea, MA (US)

Correspondence Address: Donald N. Halgren, 35 Central street, Manchester, MA, 01944, US

(21) Appl. No.: 12/214,924

(22) Filed: Jun. 24, 2008

Related U.S. Application Data
(63) Continuation-in-part of application No. 11/450,526, filed on Jun. 9, 2006.

(51) Int. Cl. B26D 7/06; B21D 43/00

(52) U.S. Cl. 83/133; 72/421

(57) ABSTRACT

A punch press arrangement for the manufacture of a stamped-out part from a sheet of “part” material, comprising a punch member for shaping a part from the part material, and a first shedder pin arranged in the punch member to plastically deform against the part being created to prevent “pulling” and retention of the stamped out part on the punch member on the punch member's return stroke.

This invention relates to punch or stamp presses and more particularly to power press tools which are used for defining a pre-shaped part and for stamping out such a shaped metal component from a sheet metal feed without that stamped out part sticking to the punch and/or die members, and is a continuation-in-part of my pending U.S. patent application Ser. Nos. 11/450,526 filed Jun. 9, 2006 and 29/286,413 filed Feb. 12, 2008 and 29/307,010 filed Mar. 27, 2008, each incorporated herein by reference in their entirety.

### BACKGROUND OF THE INVENTION

1. Field of the Invention

2. Prior Art

During a typical press or stamping operation, a punch is arranged to reciprocatively punch into and return from a strip of material which is fed into position between the punch, its guide and the pressed die typically therebeneath. The punch would force itself through the strip of material, removing a section of that material. The edges of the die cavity effectively cut the sheet material into what they call a “slug” where the shape of a slug conforms closely to the shape of the die cavity. The punch is then retracted from the die and the material, during the return cycle of the press stroke. The stamped-out slug is contained often within the die. After that punch stroke, the punch returns to its loaded and uppermost position to begin the process anew.

In a typical process, a stamping press can power the tool in vertical strokes at rates greater than five hundred strokes per minute as the metal strip is fed through the tool. Many punches may pierce the metal strip simultaneously. Slugs are extracted which are shaped similar in geometry to that of the punch and are pushed into the die. After each cycle, one slug after another is pushed into that die. Because of the shape of each slug conforms closely with the shape of the die cavity, after a number of slugs have been pushed into the die, these slugs can become jammed into the die. As the die material is removed, which is required to maintain that die's sharpness, the size of the cutting aperture is increased due to the taper of that die at its opening end. Therefore, the tool is more inclined to a slug “pulling” due to the reduction of the lateral forces that retain the slug within the die. After a number of such maintenance treatments, the die itself may fail to retain the slug with the undesirable consequence that the slug or part follows the punch (is pulled), and the part will not be removed easily therefrom, upon the punch's extraction from the die. Such slug “pulling” may damage the lead frame during subsequent cycling of the press and the tool. That slug may also be pulled from the die or end up under the strip material. Subsequent stroking of the tool with the dislodged slug thereat, may produce severe damage to the punch and die. Slug “pulling” is indeed an industry wide problem and efforts to overcome such pulling can have limited success. Often, the only remedy for such a problem is the premature replacement of the die component or the punch.

It is an object of the present invention to overcome the disadvantages of the prior art.

It is still a further object of the present invention, to provide an inexpensive and easily replaceable arrangement for preventing such “pulling” of a slug by the punch.

### BRIEF SUMMARY OF THE INVENTION

The present invention relates to stamp press die arrangements which are utilized in manufacturing a predefined shaped part, often called a “slug”. The power press of the present invention in a first embodiment thereof, comprises an uppermost ram which reciprocally advances and returns a punch holder from the top of the press stroke to the bottom of the press stroke. The puncher holder in this example has an internal-diameter punch holder secured to a die holder to which is secured a “knock-out” member. The knock-out member reciprocally travels within an upper die. The upper die and knock-out member are advanced from the top of the press stroke by the ram, to strike against a strip of material (typically metal, or a non-ferrous material, or nylon) supportingly held against a lower stripper member. The lower stripper member surrounds a lower compound punch. The compound punch rests on a die shoe. The compound punch has a central bore for receiving ejected slugs after the press stroke has completed pressing the punched material residing on the stripper.

The press, in this example, has a center punch extending through the knock-out member. The center punch has a longitudinal bore extending therethrough, with a “shedder pin” securedly extending therethrough. The shedder pin is utilized to biasedly “shed” or “push” the internal diameter slug from the distalmost end of the die, once the material has been punched through the central bore of the compound punch enclosed circumferentially therearound by the stripper. The knock-out member, which is utilized to pierce the material during the press stroke, to cut the outer periphery of that part being die stamped, may also have a “part” “shedder-pin” extending therethrough. The part shutter-pin is aligned parallel with the inside diameter shedder pin and has a distalmost end which extends through the knock-out member so as to bias the ejected part from “sticking” to the distalmost end of that knock-out member.

Such an arrangement of shedder pins, both the central shedder pin, for the internal diameter slug, and for the “stamped-out” part, as for example, a washer or the like, is comprised of a compressible plastic component for its cushioning effect and to provide a biasing of the ejected part from remaining “stickingly” attached to the distal end of the knock-out member because of the adherence of those two parts by the lubricating material (i.e. oil), otherwise holding them together.

An air supply nozzle may also arranged adjacent to the material supply so as to blow an air blast to effect removal of the ejected part completely away from the distalmost end of the knockout member.

During the operation, at the bottom of the press stroke, the upper die presses against the strip of “to-be” punched material against the distalmost end of the compound punch which is nested within the reciprocatable stripper. The stripper yields to the pressure of the circumferentially shaped die member and permits the piercing of that material, to define a part cut by that die (i.e. a washer or the like) against the compound punch. The knock-out member which surrounds the center punch, travels rearwardly, to permit the center punch to pierce the material, to also create a slug which is sent into the central bore of the compound punch. Upon reversal of the ram pulling the punch holder rearwardly, the resilient “center” or internal diameter “slug” shedder pin and the peripheral “part” shedder pin deformably press against the now unbiased, fully formed and created “part” so as to loosen it from adhesion from the distalmost end of the knock-out member. The air blow off jet thus now effectively removes the stamped part from the area of travel of the punch press members.

The central and peripheral shedder pins thus have permitted the stamped part to be freed from its potential oil-influenced adhesion to the knockout member, thus preventing potential jamming of the apparatus and shut down of the operation.

The invention thus comprises a punch press arrangement for the manufacture of a stamped-out part from a sheet of “part” material, comprising a knock-out member reciprocably movable against the part material, a punch for shaping a part from the part material, a first “shedder pin” arranged in the knock-out member to plastically deform and bias against the part being created to prevent “pulling” of the part by the knock-out member on its return stroke. The first shedder pin may be arranged in a non-central location in the knock-out member. The arrangement may include a second shedder pin arranged in a further or central location in the knock-out member. The first shedder pin has a distal tip which extends beyond the distalmost end of the knock-out member. The second shedder pin has a distal tip which extends beyond the distalmost end of the knock-out member. The first shedder pin is preferably comprised of an elongated shaft of resilient plastic material. The second shedder pin is preferably also comprised of an elongated shaft of resilient plastic material.

The invention also includes a method of eliminating the “pulling” of a stamped-out part by a knock-out member in a punch press arrangement, comprising one or more of the following steps: placing an elongated compressible plastic shedder pin in a knock-out member of that punch press arrangement; arranging a distal end of the shedder pin to extend beyond the distal end of the knock-out member; and plastically compressing the shedder pin against the part as the punch press arrangement cuts out that part during the stamping operation. The method may include: arranging a second shedder pin in the knock-out member to press against a second portion of the part being stamped out.

The invention also comprises a method of eliminating the “pulling” of a stamped-out-part from a part material layer by a punch member in a “progressive” punch press arrangement, comprising: placing an elongated compressible plastic shedder pin in a first punch member of that progressive punch press arrangement; placing an elongated compressible plastic shedder pin in a further punch member of that progressive punch press arrangement; arranging a distal end of the shedder pins to extend beyond the distal end of the first punch member and the further punch member; and plastically compressing the shedder pins against the part material layer as the punch press arrangement cuts out that part from the part material layer during the stamping operation. The method may include: arranging at least a second shedder pin in the further punch member to press against a second portion of the part being stamped out, wherein the “at least second” shedder pin may be arranged through the further punch member in a non-central alignment therethrough; and wherein the at least second shedder pin may comprise a plurality of shedder pins arranged in an annular array, each shedder pin extending respectively, longitudinally through a plurality of elongated bores of the further punch. The shedder pin is preferably made of a deformable material such as for example, urethane.

### BRIEF DESCRIPTION OF THE DRAWINGS

The objects and advantages will become more apparent, when viewed in conjunction with the following drawings in which:

FIG. 1 is a side elevational view, partly in section, of a compound punch press or stamp press assembly showing it at its top of the press stroke;

FIG. 2 is a view similar to Figure one, showing the punch press assembly at the bottom of the press stroke;

FIG. 3 is a view of the punch press assembly, similar to Figure one, with a stamped part there adjacent, about to be ejected from adhesion from the knock-out member before a subsequent stroke of the punch press;

FIG. 4 is a side elevational view, in section, showing a knock out member with a stamp “part” shedder pin arranged therewithin;

FIG. 5 is a side elevation view, in section, of a center punch, with an internal diameter “slug” shedder pin arranged therewithin;

FIG. 6 is a side elevational view with a collar type shedder pin utilized for the internal diameter of a center punch;

FIG. 7 is a side elevational view of a collar type shedder pin utilized within a knock out member in its central bore therethrough;

FIG. 8 is a perspective view of a punch used for the initial progressive “center” or “ID” punching of for example, a washer;

FIG. 9 is a perspective view of a punch used for progressive “OD” punching of a washer; and

FIG. 10 is a side elevational view of a progressive punching operation, for punching for example, a washer.

### DETAILED DESCRIPTION OF THE PREFERRED EMBODIMENTS

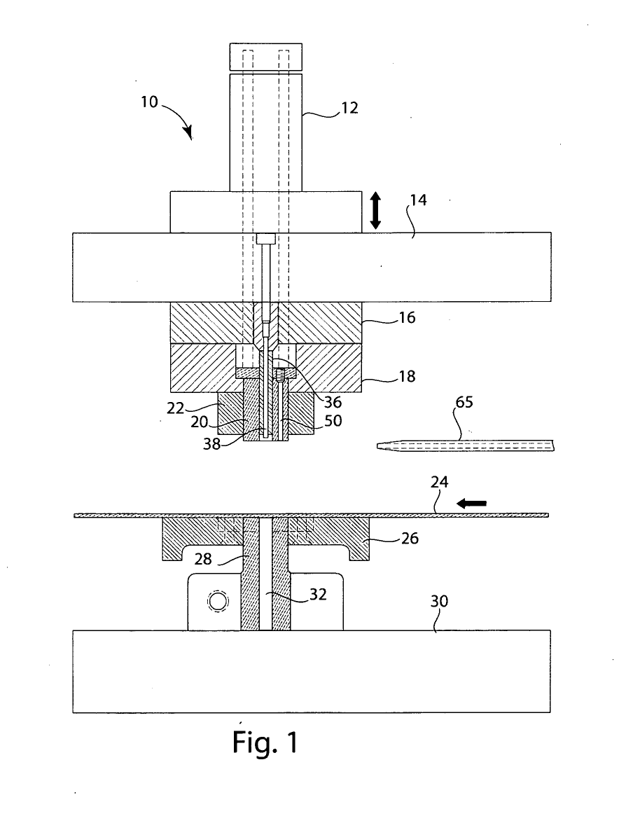

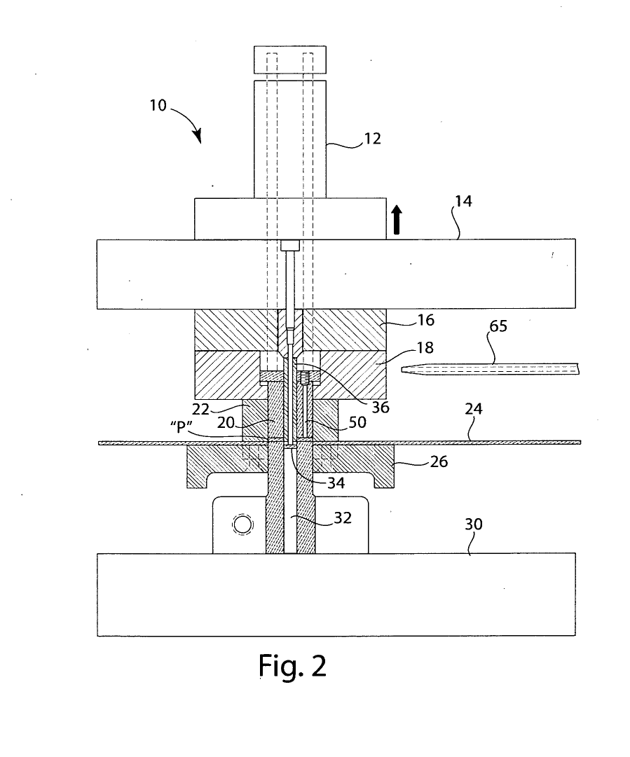

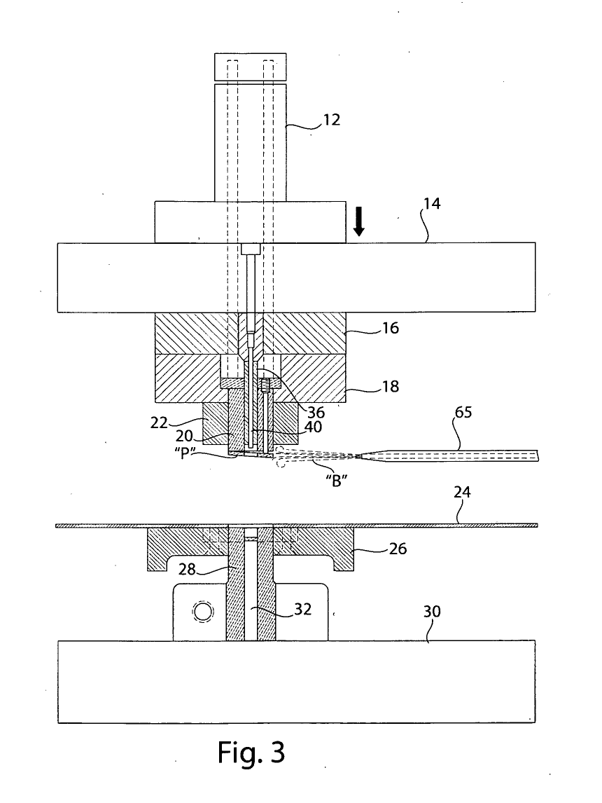

Referring now to the drawings in detail, and particularly to FIGS. 1, 2 and 3, there is shown the present invention which comprises stamp press die arrangements which are utilized in manufacturing a predefined shaped part often called a “slug”. The “compound” power press 10 of the present invention, comprises an uppermost ram 12 which reciprocally advances and returns a punch holder 14 from the top of the press stroke, as shown in FIG. 1, to the bottom of the press stroke as represented in FIG. 2 and back to the top of the stroke, as represented in FIG. 3. The puncher holder 14 in this example has an internal-diameter punch-holder 16 secured to a die holder 18 to which is secured a knock-out member 20. The knock-out member 20 reciprocally travels within an upper die 22, circumferentially disposed therearound. The upper die 22 and the knock-out member 20 are advanced from the top of the press stroke by the ram 12, as shown in FIG. 1, to strike against a strip of material 24, (typically metal), supportingly held against a lower stripper member 26. The lower stripper member 26 surrounds a lower compound-punch 28. The compound-punch 28 rests on a fixed die shoe 30. The compound-punch 28 has a central bore 32 for receiving ejected slugs 34, after the press stroke has completed pressing the punched material 24 residing on the stripper 26, as represented in FIG. 2.

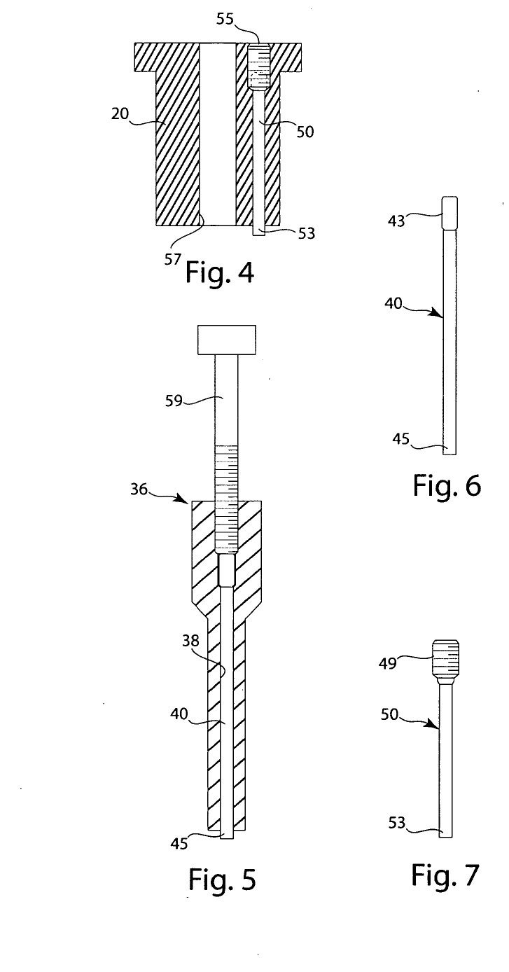

The compound press 10, in this example, has a center punch 36, extending through the knock-out member 20. The center punch 36, also shown in FIG. 5, has a longitudinal bore 38 extending therethrough, with a “collar type” shedder pin 40 securedly extending therethrough. The collar type shedder pin 40 is also shown in FIG. 6, and comprises an elongated shaft of compressible material, such as thermoplastic or the like, having a pinched collar 43 at its proximalmost end, as shown in FIG. 6. The centrally disposed shedder pin 40 is received into the bore 57 shown in FIG. 4, of the knock-out member 20 and held therein by a bolt 59 through the punch holder 14.

The centrally disposed collar type shedder pin 40, has a compressible distal tip 45, which extends beyond the knock-out member 20, (also shown in FIG. 5) and is utilized to strike and biasedly press against and effectively shed the internal diameter slug 34 from the distalmost end of that upper die 22, once the material 24 has been punched through the central bore of the compound punch 28 enclosed circumferentially therearound by the stripper 26. The die 22, which is utilized to pierce the material 24 during the press stroke, to cut the outer periphery of that “part” “P” being die stamped, (shown in FIG. 2), may also have a generally almost peripherally or non-centrally disposed “part” shedder-pin 50 extending therethrough, as represented in FIGS. 1, 2 and 3, which shedder pin 50 is also shown by itself in FIG. 7. The “part” shedder pin 50 has a proximal end 51 comprised of a set-screw 55, shown in FIG. 4, which permits it to be threadedly received into and threadedly removed from the proximal end of the knock-out member 20, shown in FIG. 4. The “part” shedder-pin 50 is aligned parallel with the inside diameter shedder pin 40 and has a distalmost end 53 which extends through and beyond the knock-out member 20, as shown in FIGS. 1, 2, 3 and 4, so as to bias the stamped part “P” from “sticking” to the distalmost end of that knock-out member 20. The shedder pin 50 has a proximal end comprised of a set screw 49 received thereon, as represented in FIG. 7.

Such an arrangement of shedder pins 40 and 50, both the central shedder pin, for the internal diameter slug 34, and for the “stamped-out” part “P”, as for example, a washer or the like, is comprised of a compressible plastic component for its cushioning effect and to provide a biasing of the stamped part(s) from remaining stickingly attached to the distal end of the knock-out member 20 because of the adherence of those two parts 20 and “P” by the lubricating material (i.e. oil), otherwise holding them together.

An air supply nozzle 65 is also arranged adjacent to the material supply so as to blow a timed air blast “B” to effect removal of the stamped part “P” completely away from the distalmost end of the knock-out member 20.

During the presses operation, at the bottom of the press stroke, as represented in FIG. 2, the knock-out member 20 presses against the strip of “to-be” punched material 24 against the distalmost end of the compound punch 28 which is nested within the reciprocatable stripper 26. The stripper 26 yields to the pressure of the circumferentially shaped die member 20 and permits the piercing of that material, to define a part cut “P” by that die (i.e. a washer or the like) against the compound punch 28. The knock-out member 20 which surrounds the center punch 36, travels rearwardly, to permit the center punch 36 to pierce the material 24, to also create a slug 34 which is sent into the central bore 32 of the compound punch 28. Upon reversal of the ram pulling the punch holder 14 rearwardly, as represented in FIG. 3, the resilient “center” or internal diameter “slug” shedder pin 40 and the peripheral “part” shedder pin 50 compressibly press against the now unbiased, fully formed and created “part” “P” so as to loosen it from adhesion from the distalmost end of the knock-out member 20. The air blow-off jet 65 thus now effectively removes the stamped part “P” from the area of travel of the punch press members.

The central and peripheral shedder pins 40 and 50 thus have permitted the stamped part “P” to be freed from its potential adhesion to the knockout member 20, thus preventing potential jamming of the apparatus and the potential shut down of the operation.

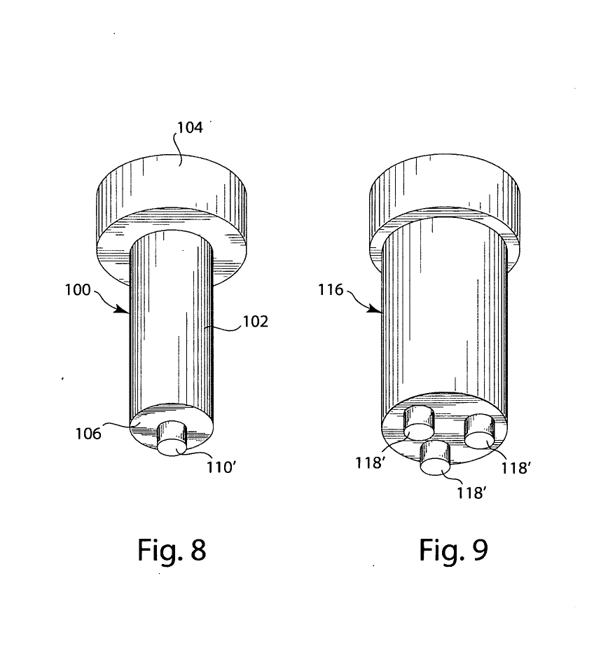

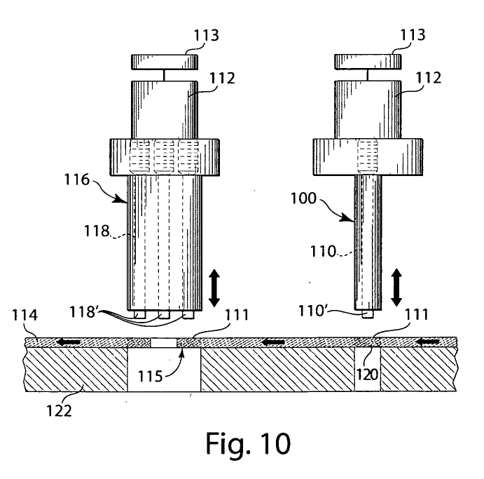

A further preferred embodiment of the punch arrangement of the present invention is shown in FIGS. 8 and 9, representing punches utilized in a “progressive” punching operation which operation itself represented in FIG. 10, wherein a central opening or hole 109 is punched out, then at a downstream located punch 116, a second opening 111 is pierced around the first opening, thus creating for example, a washer 115, which falls through the die opening in the material support platen 122, represented in FIG. 10.

FIG. 8 shows a “first” or “ID” punch 100 having a central body portion 102 with head end 104 and a “punch” or distal end 106. A central, longitudinally directed bore 108 extends through the punch body 102, and encloses a single shedder pin 110. This shedder pin 110 has its distalmost end extending slightly beyond the punch end 106 of the punch 100. The back end of the pin 110 is held in place within the first punch 100 by a connector plate 112, which is part of the press drive mechanism 113 to reciprocably move the punch 100 through and retract from a sheet of material 114, as represented in FIG. 10. A similar arrangement is shown on the second punch 116, in FIG. 9, with a plurality of shedder pins 118 disposed in an annular pattern through the punch 116. The shedder pins 110 and 116 are preferably made of a soft, resilient mold or extrusion of urethane to deform/compress upon the punches 100 and 116 striking and piercing the material 114, and subsequently re-expanding/un-deforming their respective distal tips 110′ and 118′ of their respective shedder pins 100 and 116 to its original size, pushing off any “slug” of material 120 or washer 115 itself, which might otherwise stick to the distal (punching) end of the punches 100 and 116 supported on the platen 122 on which the material 114 is intermittently advanced/moved to permit the “progressive” punching to occur.

1. A punch press arrangement for the manufacture of a stamped-out part from a sheet of “part” material, comprising:
a punch member for piercedly shaping a part from the part material;
a first “shedder pin” having a distal end arranged extend through the punch member to plastically deform against the part being created to prevent “pulling” of the part by the punch member on its return stroke.

2. The punch press arrangement as recited in claim 1, wherein said first shedder pin is arranged to extend through and beyond a central location in the punch member.

3. The punch press arrangement as recited in claim 1, including a shedder pin arranged in a non-central location in the punch member.

4. The punch press arrangement as recited in claim 1, wherein the first shedder pin has a distal tip which extends beyond the distalmost end of the punch member.

5. The punch press arrangement as recited in claim 3, wherein the shedder pin has a distal tip which extends beyond the distalmost end of the punch member.

6. The punch press arrangement as recited in claim 1, wherein the first shedder pin is comprised of an elongated shaft of resilient plastic material.

7. The punch press arrangement as recited in claim 3, wherein the shedder pin is comprised of an elongated shaft of resilient plastic material.

8. A method of eliminating the “pulling” of a stamped-out-part by a knock-out member in a compound punch press arrangement, comprising:
placing an elongated compressible plastic shedder pin in a knock-out member of that punch press arrangement;
arranging a distal end of the shedder pin to extend beyond the distal end of the knock-out member; and
plastically compressing the shedder pin against the part as the punch press arrangement cuts out that part during the stamping operation.

9. The method as recited in claim 8, including:
arranging a second shedder pin in the knock-out member to press against a second portion of the part being stamped out.

10. A method of eliminating the “pulling” of a stamped-out-part from a part material layer by a punch member in a progressive punch press arrangement, comprising:
placing an elongated compressible plastic shedder pin in a first punch member of that progressive punch press arrangement;
placing an elongated compressible plastic shedder pin in a further punch member of that progressive punch press arrangement;
arranging a distal end of the shedder pins to extend beyond the distal end of the first punch member and the further punch member; and
plastically compressing the shedder pins against the part material layer as the punch press arrangement cuts out that part from the part material layer during the stamping operation.

11. The method as recited in claim 10, including:
arranging at least a second shedder pin in the further punch member to press against a second portion of the part being stamped out.

12. The method as recited in claim 11, wherein the at least second shedder pin is arranged through the further punch member in a non-central alignment therethrough.

13. The method as recited in claim 12, wherein the at least second shedder pin comprises a plurality of shedder pins arranged in an annular array each shedder pin extending respectively, longitudinally through a plurality of elongated bores of the further punch.

14. The method as recited in claim 10, wherein the shedder pin is made of urethane.
